(19) United States
(12) Patent Application Publication
(10) Pub. No.: US 2015/0308571 A1
(43) Pub. Date: Oct. 29, 2015

(54) PARKING OVERRIDE DEVICE FOR A SHIFT-BY-WIRE TRANSMISSION

(71) Applicant: FORD GLOBAL TECHNOLOGIES, LLC, Dearborn, MI (US)

(72) Inventors: Susan M. WYATT, Milford, MI (US); Todd Curtis SPAULDING, Ann Arbor, MI (US); Emad AL-REGIB, Westland, MI (US); Louis Aaron NAGY, Canton, MI (US); Brian J. DEURLOO, Howell, MI (US)

(73) Assignee: FORD GLOBAL TECHNOLOGIES, LLC, Dearborn, MI (US)

(21) Appl. No.: 14/264,096

(22) Filed: Apr. 29, 2014

(51) Int. Cl. F16H 63/34

(52) U.S. Cl. CPC F16H 63/3491; F16H 63/3425

(57) ABSTRACT

A shift-by-wire transmission includes a gear set having a gear, a shiftable member that is selectively engageable with the gear to put the vehicle in PARK, and a first intermediate member that is coupled with the shiftable member. The first intermediate member has an engaged position, with the shiftable member engaged with the gear and a disengaged position, with the shiftable member disengaged from the gear, and is biased toward the engaged position. An actuator is coupled with the first intermediate member. The transmission includes a second intermediate member with a nominal position and an override position. In the nominal position the second intermediate member does not move in response to the first intermediate member moving between the engaged position and disengaged position. Moving the second intermediate member from the nominal position to the override position moves the first intermediate member from the engaged position to the disengaged position.

### TECHNICAL FIELD

The present invention relates to automatic transmissions and in particular to shift-by-wire transmissions.

### BACKGROUND

A traditional automatic transmission includes a transmission control device employed to control the transmission of a motor vehicle. The transmission control device is used to select several ranges, such as Park, wherein the transmission is locked to prevent the vehicle from moving, Neutral, wherein the transmission allows the vehicle to be moved freely, such as when being towed, Reverse, wherein the transmission allows the vehicle to move backwards, and one or more Drive ranges that enable forward motion of the vehicle. Usually, the transmission control device is in the form of a lever connected to the transmission via a mechanical connection, such as a cable. Typically, the lever is also connected to an indicator. As the transmission control mechanism is moved from one range to another, the mechanical connection physically shifts the transmission to the selected setting and the indicator moves to show the driver which range has been selected. Even if the vehicle is turned off, the driver is able to determine the current transmission range from the indicator and, in some cases, is able to move the transmission control mechanism to Neutral if, for example, the vehicle is to be towed.

The traditional automatic transmission utilizes multiple friction elements for automatic gear ratio shifting. Broadly speaking, these friction elements may be described as torque establishing elements although more commonly they are referred to as clutches or brakes. The friction elements function to establish power flow paths from an internal combustion engine to a set of vehicle traction wheels. During acceleration of the vehicle, the overall speed ratio, which is the ratio of a transmission input shaft speed to a transmission output shaft speed, is reduced during a ratio upshift as vehicle speed increases for a given engine throttle setting. A downshift to achieve a higher speed ratio occurs as an engine throttle setting increases for any given vehicle speed, or when the vehicle speed decreases as the engine throttle setting is decreased. Various planetary gear configurations are found in modern automatic transmissions. However, the basic principle of shift kinematics remains similar. Shifting an automatic transmission having multiple planetary gear sets is accompanied by applying and/or releasing friction elements to change speed and torque relationships by altering the torque path through the planetary gear sets. Friction elements are usually actuated either hydraulically or mechanically based on the position of the transmission control device.

In a shift-by-wire transmission arrangement, the mechanical connection between the transmission control device and the transmission is eliminated. Instead, the transmission control device transmits an electrical signal to an electronic controller, which directs separate actuators to apply or release the various friction elements to obtain a desired gear ratio. The control device is no longer necessarily in the form of a lever because the control device is no longer moving a mechanical connection for controlling the transmission. Instead, the control device is typically an electro-mechanical interface (e.g., a series of buttons, lever or knob) that is used to instruct the transmission to switch between the transmission ranges.

### SUMMARY

A shift-by-wire transmission according to the present disclosure includes a shiftable member that is selectively engageable with a park gear gear to put the vehicle in PARK. The transmission additionally includes a first intermediate member that is coupled with the shiftable member. The first intermediate member has an engaged position and a disengaged position and is biased toward the engaged position. The engaged position corresponds with the shiftable member being engaged with the gear, and the disengaged position corresponds with the shiftable member being disengaged from the gear. The transmission additionally includes an actuator coupled with the shiftable member via the first intermediate member. The transmission further includes a second intermediate member. The second intermediate member has a nominal position and an override position. In the nominal position the second intermediate member does not move in response to the first intermediate member moving between the engaged position and disengaged position. In addition, moving the second intermediate member from the nominal position to the override position moves the first intermediate member from the engaged position to the disengaged position.

In some embodiments, the first intermediate member includes a first hub and the second intermediate member includes a second hub. The first and second hubs are pivotable about a common axis. Moving the first intermediate member from the engaged position to the disengaged position includes pivoting the first hub about the axis, and moving the second intermediate member from the nominal position to the override position includes pivoting the second hub about the axis. In one such embodiment, the second hub is coupled to and configured to jointly pivot with a flange. The flange has a plane of pivoting motion. The first hub has an outer face and a pin extending from the outer face through the plane of pivoting motion, such that pivoting the second intermediate member from the nominal position to the override position engages the flange with the pin to pivot the first intermediate member from the engaged position to the disengaged position. In some embodiments, the transmission additionally includes a fastener removably retaining the second intermediate member in the nominal position.

A shift-by-wire transmission assembly according to the present disclosure includes a first member that is moveable between engaged and disengaged positions and a second member that is moveable between nominal and override positions. The first member is biased to the engaged position. The transmission assembly additionally includes an actuator configured to move the first member from the engaged to the disengaged positions while the second member remains stationary. Moving the second member from the nominal to override positions moves the first member from the engaged to disengaged positions.

In one embodiment, the first member and second member are pivotable about a common axis. The first member is moveable between the engaged and disengaged positions by pivoting about the axis and the second member is movable between the nominal and override positions by pivoting about the axis.

In an additional embodiment, moving the second member from the nominal to override positions moves the first member from the engaged to disengaged positions, and further to a first member override position. Some such embodiments additionally include a controller. The controller is configured to, in response to the first member being moved to the first member override position, signal an alert to a driver indicating that a transmission override mode is enabled.

Some embodiments additionally include a fastener removably retaining the second member in the nominal position. Various other embodiments additionally include a spring biasing the second member in the nominal position. Some embodiments include a parking pawl coupled with the first member selectively engageable with a gear. In such embodiments, the first member engaged position corresponds with the parking pawl being engaged with the gear, and the first member disengaged position corresponding with the parking pawl being disengaged from the gear.

An override system for a transmission according to the present disclosure includes a first hub coupling a hydraulic or electric actuator with a parking pawl. The parking pawl is selectively engaged with a gear. The first hub is configured to pivot about an axis, with an engaged position corresponding with the parking pawl being engaged with the gear and a disengaged position corresponding with the parking pawl being disengaged from the gear. The override system additionally includes a second hub that is configured to pivot about the axis. The second hub has a nominal position and an override position. When in the nominal position, the second hub does not move in response to the first hub moving between the engaged and disengaged positions. Furthermore, moving the second hub from the nominal position to the override position moves the first hub from the engaged position to the disengaged position.

In one embodiment, the override system additionally includes a finger member coupled with the second hub and configured to pivot with the second hub. The finger member has a pivot plane. The override system additionally includes a pin extending from a face of the first hub through the pivot plane, such that moving the second hub from the nominal position to the override position engages the finger member with the pin and moves the first hub from the engaged position to the override position.

Some embodiments additionally include a fastener removably retaining the second hub in the nominal position. In one embodiment, moving the second hub from the nominal position to the override position moves the first hub from the engaged position to the disengaged position, and further to a first hub override position. Such an embodiment may additionally include a controller configured to, in response to the first hub being moved to the first hub override position, signal an alert to a driver indicating that a transmission override mode is enabled.

Embodiments according to the present disclosure provide a number of advantages. For example, the present disclosure provides an override for shifting a transmission out of park in the absence of engine power. Systems and methods according to the present disclosure may avoid routing override cables to a passenger cabin, thus reducing packaging complexity and cost. Furthermore, systems and methods according to the present disclosure provide an externally accessible lever that remains stationary during normal operating conditions, and thus is less susceptible to damage due to mud or ice buildup on the lever.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of a vehicle including a shift-by-wire transmission according to the present disclosure;

FIG. 2 is an isometric view of a parking assembly of a shift-by-wire transmission including an override system according to the present disclosure;

FIG. 3 is an isometric view of a parking override system according to the present disclosure;

FIG. 4 is an isometric view of a parking override system according to the present disclosure; and

FIGS. 5A-5C illustrate operation of a parking override system according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A shift-by-wire transmission refers to an arrangement having no mechanical connection between a transmission control device and the transmission. Instead, a user-operated gear shift module transmits an electrical signal to an electronic controller, which directs separate actuators to apply or release the various friction elements, such as clutches or brakes, to obtain a desired gear ratio. In some embodiments, the transmission may be provided with a parking pawl that is operated by one of the actuators. The parking pawl may engage with at least one gear in the transmission to inhibit vehicle motion or release from the at least one gear to permit vehicle motion. The parking pawl may be engaged in response to a driver shifting the transmission to PARK. Of course, various other parking elements may also be used to inhibit vehicle motion, such as a parking brake.

In some configurations, the actuators operating the friction elements and parking pawl are hydraulic actuators. Under normal vehicle operation, an engine drives a transmission pump to supply hydraulic pressure to the actuators and enable application or release of the friction elements or parking brake. Because there is not a mechanical connection between the gear shift module and the transmission, in the absence of hydraulic pressure to the actuators, a driver will be unable to shift the transmission between gears. When the engine is off, the gear shift module may not be usable to shift gears.

Under some circumstances, however, it may be desirable to shift the vehicle from PARK to another gear without the engine running. For example, if the engine is inoperable, it may be desirable to shift the transmission out of PARK to facilitate towing. As an additional example, it may be desirable to roll the vehicle to a new location without running the engine. Using the standard gear shift module, shifting out of PARK without operating the engine is not possible. Consequently, the transmissions may be provided with a manual override mechanism. This may include a mechanism available under the vehicle hood or a cable mechanism available within the cabin. Such solutions may be difficult for a user to access, difficult to route through a vehicle, and also add complexity and cost to the vehicle. In addition, known override mechanisms that are accessible under the vehicle hood include an external override lever that moves during normal transmission operation. Such external moving parts are susceptible to mud, snow, ice, or other debris accumulating and inhibiting transmission operation.

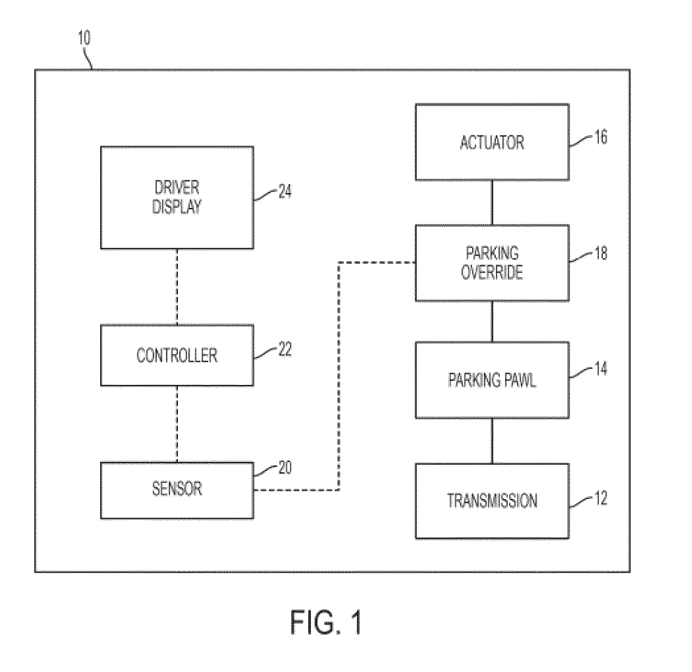

Referring now to FIG. 1, a vehicle 10 is illustrated in schematic form. The vehicle 10 includes a shift-by-wire transmission 12. The transmission 12 includes an associated parking pawl 14 that is selectively engageable with a gear (not illustrated) in the transmission to restrain vehicle motion. The transmission 12 additionally includes at least one associated actuator 16. The actuator 16 is configured to selectively engage or disengage the parking pawl 14. Additional actuators (not shown) may control various other friction devices, such as clutches and brakes, to selectively transmit power from a vehicle engine (not illustrated) to vehicle wheels (not illustrated) according to various gear ratios. The transmission additionally includes an associated parking override device 18, which will be discussed in greater detail below. The parking override device 18 is configured to selectively shift the vehicle out of PARK in response to a manual input.

The vehicle 10 additionally includes a sensor 20 configured to detect a position of the parking override device 18. The sensor 20 is in communication with or under the control of at least one controller 22. In various embodiments, the controller or controllers 22 may be a vehicle system controller or a plurality of controllers in communication with each other. The controller or controllers 22 may, of course, be in communication with various other sensors and vehicle components not illustrated in FIG. 1. The controller 22 is configured to transmit various messages and/or alerts to a driver display 24. The driver display may include a dashboard warning light, a multi-function display, an audio alert, or various other methods of communicating information to a user.

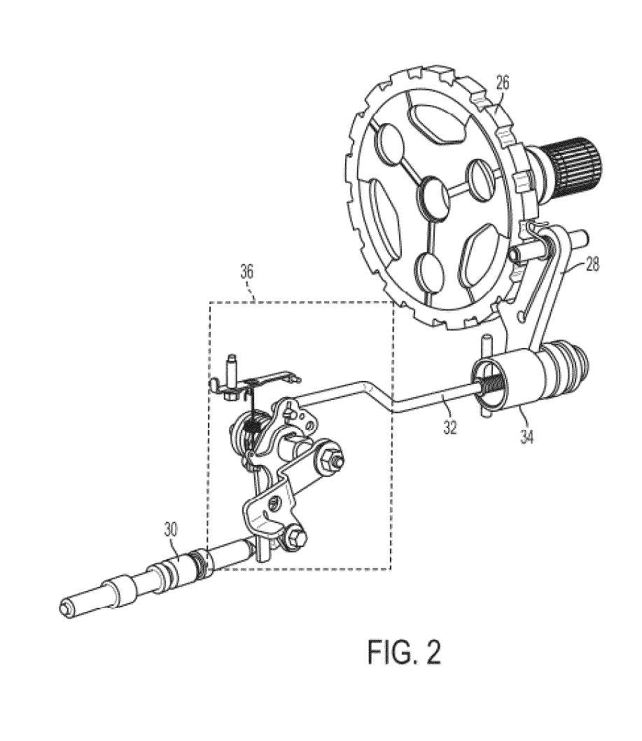

Referring now to FIG. 2, an isometric view of a parking assembly of a shift-by-wire transmission including an override system is illustrated. The transmission includes at least one gear set 26. A parking pawl 28 is selectively engageable with a gear of the gear set 26. When engaged, the parking pawl 28 restrains vehicle motion. An actuator 30, which may be hydraulic or electric, engages and/or disengages the parking pawl 28 via a link arm 32 and linkage 34. A parking override device 36 operably connects the actuator 30 with the link arm 32.

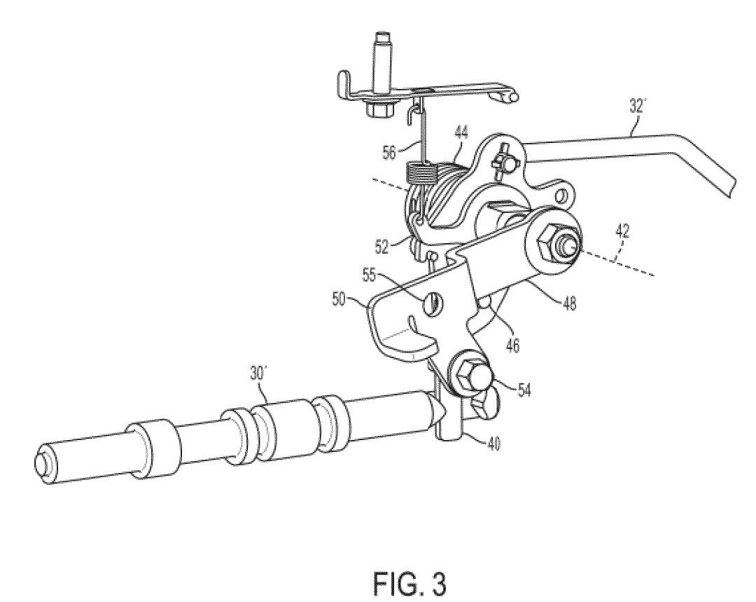

Referring now to FIG. 3, an isometric view of a parking override assembly is illustrated. An actuator 30′, which in this embodiment includes a hydraulic valve, is drivably coupled with an inner lever 40. The inner lever 40 is, at an opposite end, drivably connected to a link arm 32′. The inner lever is movable between various positions, including a first position, which may be a “PARK” position in which a parking pawl is engaged with a gear of a transmission, and a second position, which may be a “not PARK” position in which a parking pawl is disengaged from a gear of a transmission. The inner lever 40 is configured to pivot about a pivot axis 42 among the various positions. A torsion spring 44 is configured to apply a biasing torque to the inner lever 40. In a preferred embodiment, the torsion spring 44 is configured to apply a biasing torque toward the PARK position. Such an assembly may be referred to as having a “return to PARK” function. The inner lever additionally includes a pin 46 extending from a face opposite the torsion spring 44. It should be noted that in this context, “inner” refers to the positioning of the lever relative to a transmission case. The inner lever 40 and associated components, including the actuator 30′ and link arm 32′, are preferably retained within the transmission case.

The parking override assembly additionally includes an override lever 50 that is also configured to pivot about the pivot axis 42. The override lever 50 is configured to pivot between various positions, including a first position, which may be a “nominal” position for normal operation, and a second position, which may be an “override” position. The override lever 50 is positioned outside the case for ease of access. The override lever 50 is configured to pivot separately from the inner lever 40, such that as the inner lever 40 pivots between the “PARK” and “not PARK” positions during normal operation, the override lever remains stationary. The override lever 50 is coupled with an actuating arm or finger 52, such that the override lever 50 and actuating arm 52 pivot together about the pivot axis 42. The actuating arm 52 is preferably retained within a transmission case. The actuating arm 52 defines a plane of pivoting motion that passes through the pin 46 of the inner lever 40. The override lever 50 includes a first fastener hole 54 with an associated fastener securing the override lever 50 to the transmission case. The override lever 50 additionally includes a second fastener hole 55. The override lever 50 may also include an extension spring 56 coupled to the actuating arm 52 and biasing the override lever 50 toward the nominal position.

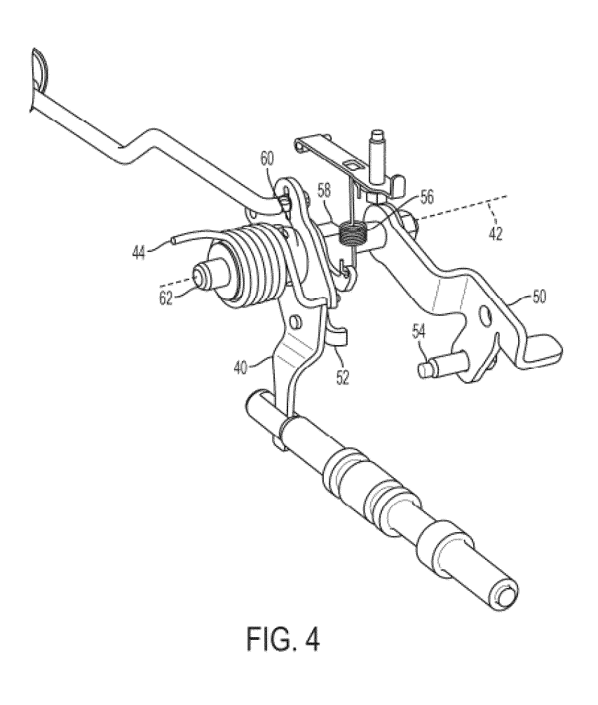

Referring now to FIG. 4, a rear isometric view of the parking override assembly is shown. In this view, it may be seen that the override lever 50 is pivotable about the pivot axis 42 via a first hub 58 and the inner lever 40 is pivotable about the pivot axis 42 via a second hub 60. In this embodiment, the first hub 58 is an inner hub pivotable about a shaft 62 and the second hub 60 is an outer hub pivotable about the first hub 58. Other configurations are, of course, possible.

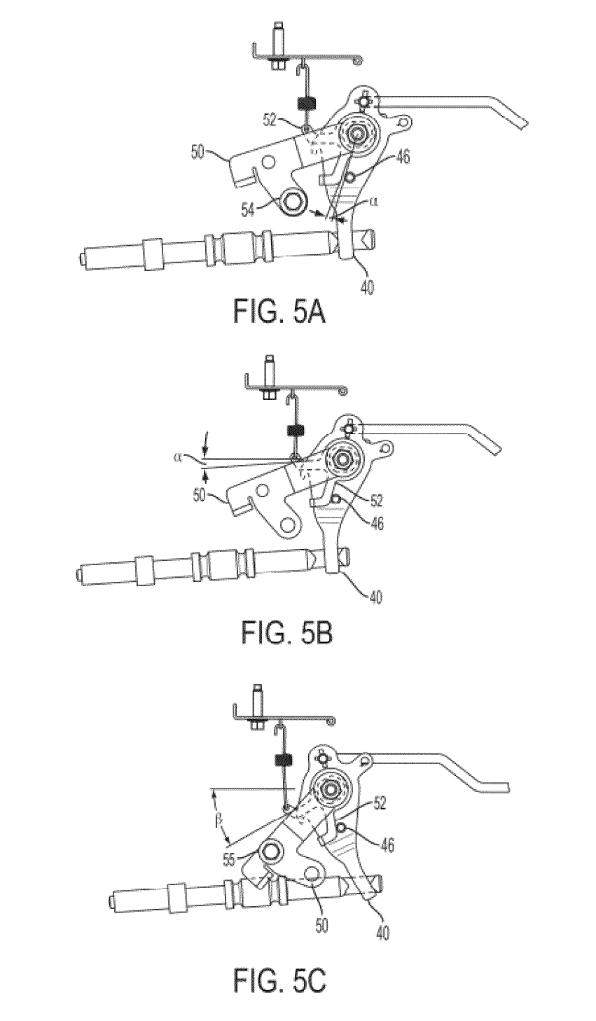

Referring now to FIGS. 5A-5C, operation of a parking override device according to the present disclosure is illustrated. In FIG. 5A, the assembly is illustrated in the “PARK” position. The inner lever 40 is in the PARK position. The fastener 54 retains the override lever 50 in the nominal position. Preferably, a small angular gap α is provided separating the actuator arm 52 and pin 46. In an exemplary embodiment, the angular gap α is 4°.

In FIG. 5B, the fastener has been removed from the first fastener hole 54 and the override lever 50 has been pivoted away from the nominal position until the actuator arm 52 contacts the pin 46. In embodiments including an angular gap, this involves rotating the override lever α degrees. At this stage of operation, the inner lever 40 is still in the “PARK” position.

In FIG. 5C, the override lever 50 has been pivoted an additional β degrees to the override position. The contact between the actuator arm 52 and the pin 46 causes the inner lever 40 to also pivot β degrees. Pivoting the inner lever 40 by β degrees moves the inner lever 40 from the “PARK” position to at least the “not PARK” position and disengage the parking pawl. The vehicle is shifted out of PARK and may be moved from a current vehicle location. The fastener may be inserted into the second fastener hole 55 to retain the override lever 50 in the override position, and thus maintain the inner lever 40 in the “not PARK” position.

In a preferred embodiment, β degrees is a greater angular displacement than required to move the inner lever 40 from the “PARK” position to the “not PARK” position. In such an embodiment, pivoting the inner lever β degrees moves the inner lever 40 from the “PARK” position to a third position, which may be an override position. Preferably a sensor, such as sensor 20 illustrated in FIG. 1, detects the presence of the inner lever in the override position and sends a signal indicating this status to a controller, such as controller 22. In response to the detected presence of the inner lever 40 in the override position, the controller 22 may take various actions. As an example, the controller 22 may signal an alert to a driver via the driver display 24 indicating that the transmission is in an override state in which PARK is unavailable. As another example, the controller may activate a vehicle parking brake in response to a driver selection of PARK on a gear shift module when the transmission is in the override state.

Variations on the above are, of course, possible. For example, in some embodiments, a cabling system may be provided from the override lever into a vehicle cabin, enabling a driver to manually shift the vehicle out of PARK without accessing the engine compartment. Additionally, in some embodiments, no extension spring is included to bias the override lever toward the nominal position. In such embodiments, only a fastener is included to maintain the override lever in the nominal position.

As may be seen from the above description, the present disclosure provides an override for shifting a transmission out of park in the absence of engine power, where the override includes an override lever that remains stationary during normal operating conditions and thus is less susceptible to damage due to mud or ice buildup on the lever. Furthermore, systems and methods according to the present disclosure may avoid routing override cables to a passenger cabin, thus reducing packaging complexity and cost.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A shift-by-wire transmission comprising:
a shiftable member selectively engageable with a park gear to put a vehicle in PARK;
a first intermediate member coupled with the shiftable member and having an engaged position and a disengaged position, wherein in the engaged position the shiftable member is engaged with the park gear and in the disengaged position the shiftable member is disengaged from the park gear and being biased toward the engaged position;
an actuator coupled with the shiftable member via the first intermediate member; and
a second intermediate member having a nominal position and an override position, wherein in the nominal position the second intermediate member does not move in response to the first intermediate member moving between the engaged position and disengaged position, and moving the second intermediate member from the nominal position to the override position moves the first intermediate member from the engaged position to the disengaged position.

2. The shift-by-wire transmission of claim 1, wherein the first intermediate member comprises a first hub and the second intermediate member comprises a second hub, the first and second hubs being pivotable about a common axis, moving the first intermediate member from the engaged position to the disengaged position includes pivoting the first hub about the axis, and moving the second intermediate member from the nominal position to the override position includes pivoting the second hub about the axis.

3. The shift-by-wire transmission of claim 2, wherein the second hub is coupled to and configured to jointly pivot with a flange, the flange having a plane of pivoting motion, and the first hub has an outer face and a pin extending from the outer face through the plane of pivoting motion such that pivoting the second intermediate member from the nominal position to the override position engages the flange with the pin to pivot the first intermediate member from the engaged position to the disengaged position.

4. The shift-by-wire transmission of claim 1, further comprising a fastener removably retaining the second intermediate member in the nominal position.

5. A shift-by-wire transmission assembly comprising:
a first member moveable between engaged and disengaged positions and biased to the engaged position;
a second member movable between nominal and override positions, wherein moving the second member from the nominal to override positions moves the first member from the engaged to disengaged positions; and
an actuator configured to move the first member from the engaged to the disengaged positions while the second member remains stationary.

6. The shift-by-wire transmission assembly of claim 5, wherein the first member and second member are pivotable about a common axis, the first member is moveable between the engaged and disengaged positions by pivoting about the axis, and the second member is movable between the nominal and override positions by pivoting about the axis.

7. The shift-by-wire transmission assembly of claim 5, wherein moving the second member from the nominal to override positions moves the first member from the engaged to disengaged positions, and further to a first member override position.

8. The shift-by-wire transmission assembly of claim 7, further comprising a controller configured to, in response to the first member being moved to the first member override position, signal an alert to a driver indicating that a transmission override mode is enabled.

9. The shift-by-wire assembly of claim 5, further comprising a fastener removably retaining the second member in the nominal position.

10. The shift-by-wire assembly of claim 5, further comprising a spring biasing the second member in the nominal position.

11. The shift-by-wire assembly of claim 5, further comprising a parking pawl coupled with the first member selectively engageable with a gear, the first member engaged position corresponding with the parking pawl being engaged with the gear, and the first member disengaged position corresponding with the parking pawl being disengaged from the gear.

12. An override system for a transmission comprising:
a first hub coupling a hydraulic or electric actuator with a parking pawl and being pivotable about an axis, the parking pawl being selectively engaged with a gear, the first hub having an engaged position and a disengaged position, wherein in the engaged position the parking pawl is engaged with the gear and in the disengaged position the parking pawl is disengaged from the gear; and
a second hub pivotable about the axis and having a nominal position and an override position, wherein in the nominal position the second hub does not move in response to the first hub moving between the engaged and disengaged positions, and moving the second hub from the nominal position to the override position moves the first hub from the engaged position to the disengaged position.

13. The override system of claim 12, further comprising a finger member coupled with the second hub and configured to pivot with the second hub, the finger member having a pivot plane, and a pin extending from a face of the first hub through the pivot plane, such that moving the second hub from the nominal position to the override position engages the finger member with the pin and moves the first hub from the engaged position to the disengaged position.

14. The override system of claim 12, further comprising a fastener removably retaining the second hub in the nominal position.

15. The override system of claim 12, wherein moving the second hub from the nominal position to the override position moves the first hub from the engaged position to the disengaged position, and further to a first hub override position.
